(19) United States
(12) Patent Application Publication
(10) Pub. No.: US 2010/0133777 A1
(43) Pub. Date: Jun. 3, 2010

(54) DETACHABLE BICYCLE FRAME

(76) Inventor: KENNETH MARVIN DANIELS, Southfield, MI (US)

Correspondence Address: KENNETH MARVIN DANIELS, 19473 WEST 9 MILE ROAD, SOUTHFIELD, MI, 48075, US

(21) Appl. No.: 12/325,758

(22) Filed: Dec. 1, 2008

(51) Int. Cl. B62K 19/18

(52) U.S. Cl. 280/278; 403/204

(57) ABSTRACT

According to one embodiment, a connector assembly for assembling at least two portions of a bicycle frame has first and second connectors, adapted to be mounted to the frame. The first connector has a body with an inner aperture, a peripheral region, a threaded exterior profile greater than a body outer profile and an axial contact surface. The second connector has a body with an exterior profile, a pilot to be received in the first connector inner aperture and a peripheral region having an exterior profile and an axial contact surface. A sleeve has a first region with an aperture to receive the second connector body exterior profile, a second region with an inner profile to receive the second connector peripheral region exterior profile, and a threaded region engaging the first connector threaded exterior profile for fastening the connector assembly and maintaining engagement of the pilot and axial contact surfaces.

### CROSS-REFERENCE TO RELATED APPLICATIONS

This application claims the benefit of U.S. application Ser. No. 11/164,613 filed Nov. 30. 2005.

### BACKGROUND OF THE INVENTION

1. Field of the Invention

One aspect of the present invention relates to bicycles. Another aspect of the present invention relates to a bicycle featuring a detachable frame.

2. Background Art

Conventionally, bicycles can be classified as ones featuring a fixed frame, a foldable frame or a detachable frame. Fixed frame bicycles are generally adequate in structural strength and have less restriction on design than foldable or detachable frame bicycles. However, fixed frame bicycles occupy a relatively large amount of space during transportation and storage. When transporting a bicycle in a vehicle, a rack is often required for fastening the bicycle onto the vehicle, which can be tedious and cumbersome.

Folding frame bicycles are generally adequate in saving space during transportation and storage but are susceptible to structural weakness because of potential breakage at the folded portions of the bicycle frame. Reinforcements are often added at these folded portions of the bicycle frame, but may detract from the appearance of the bicycle.

Detachable frame bicycles generally provide the flexibility of detaching the bicycle for transportation and storage. Unfortunately, the detachable frames currently available suffer from one or more problems. A first problem can be a lack of frame alignment. A second problem can be the stability of the bicycle frame. Yet another problem can be the rigid ness associated with the frame. In addition, tools, such as wrenches, may be required to detach the frame, which may be forgotten or lost Bolts are often used in combination with the wrenches, which often rust and become difficult to remove or even become stripped and need replacing.

One aspect of the present invention is directed to a detachable bicycle frame that overcomes one or more of the problems.

### SUMMARY OF THE INVENTION

An embodiment of the present invention provides a connector assembly for assembling at least two portions of a bicycle frame. The connector assembly has a first connector, a second connector and a sleeve. The first connector of the assembly has a body which is adapted to be mounted to the bicycle frame. The body of the first connector has an inner aperture, a peripheral region and a threaded exterior profile. The peripheral region is oriented at a distal end of the first connector and has an axially contact surface. The threaded exterior profile is greater than an outer profile of the body of the first connector. The second connector of the assembly has a body adapted to be mounted to the bicycle frame with an exterior profile and a pilot extending there from.

The pilot is sized to be received in the first connector inner aperture. The body of the second connector has a peripheral region with an exterior profile and an axial contact surface for abutting the first connector axial contact surface. The sleeve of the assembly has a first region with an aperture formed there through sized to receive the second connector body exterior profile for axial translation relative thereto. The sleeve has a second region with an inner profile sized to receive the second connector peripheral region exterior profile. The sleeve has a threaded region for threaded engagement with the first connector threaded exterior profile for fastening the first connector to the second connector, maintaining engagement of the pilot in the first connector inner aperture and maintaining engagement of the first and second connector axial contact surfaces.

Another embodiment of the invention provides a bicycle having a first bicycle frame portion, a first tire, a first connector, a second bicycle frame portion, a second tire, a second connector and a sleeve. The first tire of the bicycle is mounted for rotation to the first bicycle frame portion. The first connector has a body with an inner aperture, a peripheral region and a threaded exterior profile. The peripheral region is oriented at a distal end of the first connector and has an axial contact surface. The threaded exterior profile is greater than an outer profile of the body of the first connector. The second tire is mounted for rotation to the second bicycle frame portion. The second connector is mounted on the second bicycle frame portion. The second connector has a body with an exterior profile and a pilot extending there from. The pilot is sized to be received in the first connector inner aperture. The body of the second connector has a peripheral region with an exterior profile and an axial contact surface for abutting the first connector axial contact surface. The sleeve has a first region with an aperture formed there through sized to receive the second connector body exterior profile for axial translation relative thereto. The sleeve has a second region with an inner profile sized to receive the second connector peripheral region exterior profile. The sleeve has a threaded region for threaded engagement with the first connector threaded exterior profile for fastening the first connector to the second connector, maintaining engagement of the pilot in the first connector inner aperture and maintaining engagement of the first and second connector axial contact surfaces.

Another embodiment of the invention provides a method for disassembling a bicycle. The method includes disassembling a first bicycle frame portion from a second bicycle frame portion. The method also includes assembling the first bicycle frame portion to the second bicycle frame portion for assembling the bicycle in a compact assembly.

The above embodiments, and other embodiments, objects, features, and advantages of the present invention are readily apparent from the following detailed description of embodiments of the invention when taken in connection with the accompanying drawings.

### BRIEF DESCRIPTION OF THE DRAWINGS

FIG. 1 is a side perspective view of a detachable bicycle in accordance with one embodiment of the present invention;

FIG. 2 is a front perspective drawing of a detachable bicycle in accordance with one embodiment of the present invention;

FIG. 3 is a perspective drawing of a connector for a detachable bicycle in accordance with one embodiment of the present invention.

FIG. 4 is another perspective view of the connector of FIG. 3

FIG. 5 is another perspective view of the connector of FIGS. 3 and 4

FIG. 6 is a partial view of the connector of FIGS. 4-5;

FIG. 7 is a front frame portion of the bicycle of FIG. 1;

FIG. 8 is a partial top persepective view of a tire of FIG. 1;

FIG. 9 is a partial side perspective view of a tire of FIG. 1

FIG. 10 is a side perspective view of a disassembled rear portion of the bicycle frame of the bicycle in FIG. 1.

FIG. 11 is a side perspective view of a tire of the bicycle in FIG. 1.

FIG. 12 is a partial perspective view of the front frame portion of FIG. 7.

FIG. 13 is a side perspective view of the bicycle of FIG. 2.

FIG. 14 is a side perspective view of a retainer of the bicycle of FIG. 1.

FIG. 15 is another side perspective view of the bicycle of FIG. 2.

### DETAILED DESCRIPTION OF THE EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

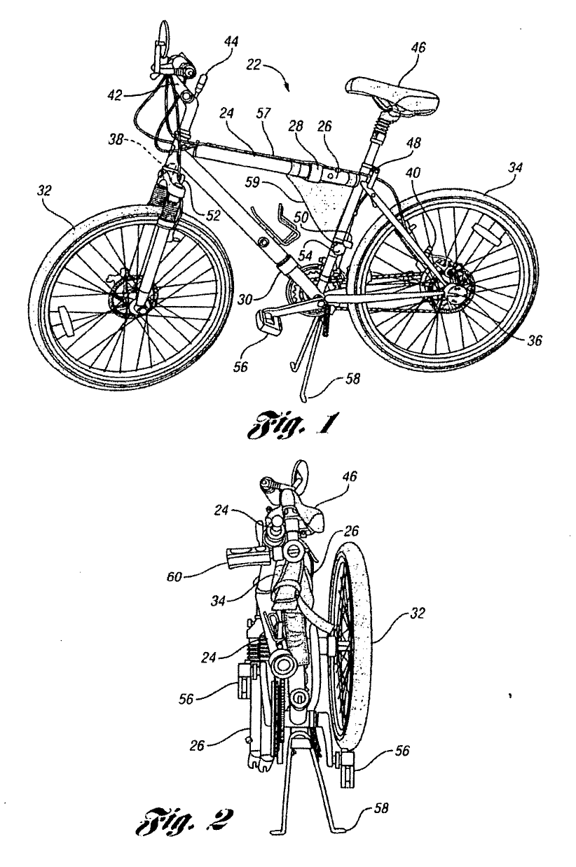

In FIG. 1, a detachable bicycle 20 is shown in a rideable assembly. The detachable bicycle 20 has a frame 22 which has a front frame portion 24 and a rear frame portion 26. The front frame portion 24 may be connected to the rear frame portion 26 by a first connector assembly 28. The front frame portion 24 may be connected to the rear frame portion 26 by a second connector assembly 30. Of course, any number of connector assemblies 28, 30 are contemplated within the scope of the present invention.

The front frame portion 24 may be connected to a first tire 32 and the rear frame portion 26 may be connected to a second tire 34. First tire 32 and second tire 34 allow for movement of the bicycle in the rideable assembly. Pedals 56 are provided on second bicycle frame portion 26. The pedals 56 are in operative connection with the second tire 34 to provide movement of the bicycle 20 in the rideable assembly. A chain mechanism may provide the operative connection between the pedals 56 and the second tire 34 as illustrated in FIG. 1; however, any suitable operative connection between the pedals 56 and the second tire 34 is contemplated within the scope of the present invention.

A detachable seat 46 may be provided on the second bicycle frame portion 26 for a user to sit on while the bicycle 20 is in the rideable assembly. The seat 46 may have a quick release 48 to detach the seat from the second bicycle frame portion 26.

Referring now to FIG. 2, the bicycle 20 from FIG. 1 is illustrated disassembled from the rideable assembly in a compact transportable assembly. The first tire 32 and the second tire 34 may rest upon the ground or an underlying support surface to allow the bicycle 20 in the compact transportable assembly to roll. A user may roll the bicycle 20 by gripping a handle 60. The handle 60 is provided on the second bicycle frame portion 26. The handle 60 may be removable from the second bicycle frame portion 26.

The pedals 56 in operative connection with the second tire 34 may be moved from a horizontal to a vertical position so that the bicycle 20 is in a more compact transportable assembly. Any suitable pedal 56 is contemplated within the scope of the present invention.

Brake and gear connectors 57 may be provided which connect to the second tire 34 with the controls which may be provided on the handle bars 42. The brake and gear connectors 57 may have a hook and loop provided near the first connector assembly 28 to allow for separation of the brake and gear connectors 57 when the bicycle 20 is disassembled.

A storage bag 59 may be provided on the bicycle 20 for holding retainers provided on the bicycle 20 on the first bicycle frame portion 24, the second bicycle frame portion 26 or any suitable location on the bicycle 20. The storage bag 59 may be removable from the bicycle 20.

As seen in FIGS. 1 and 2, the bicycle 20 may be supported by a stand 58. The stand 58 has an extended position to support the bicycle 20 as shown. The stand 58 also has a retracted position when not supporting the bicycle 20. The stand 58 can be utilized to balance and support the bicycle 20 while removing the first tire 32 and/or second tire 34.

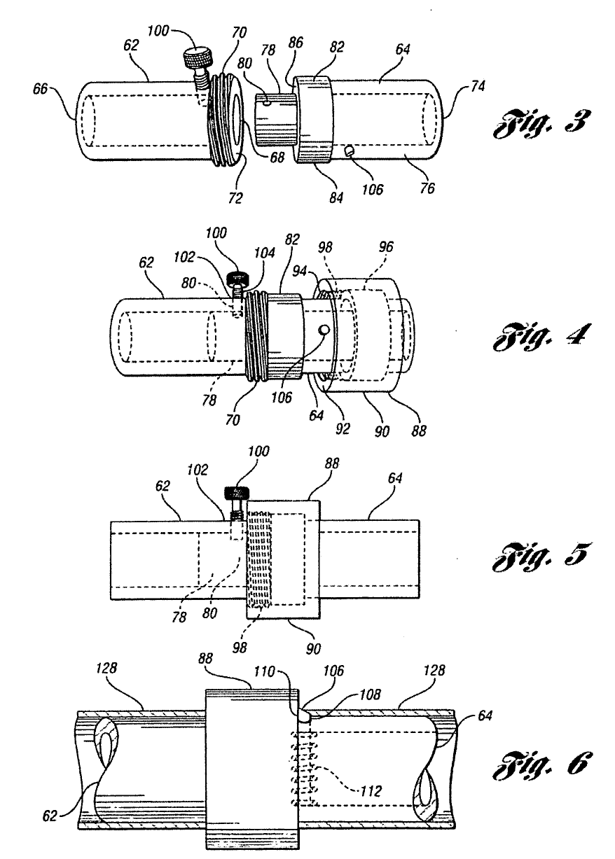

Referring now to FIGS. 3-5, a connector assembly 28 is illustrated. The connector assembly 28 may be adapted for connection to a bicycle frame. The connector 28 may be welded or brazed to the bicycle frame of FIG. 1 for example. Of course, any suitable means of connecting the connector assembly 28 to the bicycle frame is contemplated within the scope of the present invention.

The connector assembly 28 has a first connector 62 and a second connector 64. The first connector 62 is adapted to be connected to a first or second portion of a bicycle frame. In at least one embodiment, the first connector 62 is adapted to be connected to the rear frame portion 26 of the frame 22. The first connector 62 has a body 66. The body 66 may be cylindrical as illustrated. An inner aperture 68 is formed in the body 66. The body 66 may also have a peripheral region 70 provided at a distal end of the first connector 62. The peripheral region 70 may be greater than an outer profile of the body 66. The peripheral region 70 may be threaded. The peripheral region may have an axial contact surface provided at the distal end of the body 66.

The second connector 64 has a body 74 which has an exterior profile 76. A pilot 78 extends from a distal end of the body 74. The pilot 78 is sized to fit within the inner aperture 68 of the first connector 62 to provide support for the connector 28 and the bicycle frame when connected thereto. The pilot 78 has a recess 80 for alignment of the first connector 62 and the second connector 64.

The second connector body 74 has a peripheral region 82. The peripheral region 82 has an exterior profile 84. The exterior profile 84 may be generally equal to the peripheral region 70 of the first connector body 66 to be aesthetically pleasing. The peripheral region 82 has an axial contact surface 86 which may abut the axial contact surface 72 of the first connector 62 to increase the stability of the connector 28 and the bicycle frame when connected thereto.

When the pilot 78 is inserted into the aperture 68, the recess 80 may be aligned with a second aperture 102 formed in the first connector body 62. Once the recess 80 is aligned with the second aperture 102, a retainer 100 may be inserted through the aperture 102 into the recess 80 to help align the first connector 62 and second connector 64 to engage the bicycle frame, easing assembly and disassembly.

A sleeve 88 may move transversely over the second connector 64. the sleeve 88 has a first region 90 with an aperture 92 formed through. The aperture 92 is sized to receive the second connector body 74 to allow movement of the sleeve 88. The sleeve 88 has a second region 94 which has an inner profile 96 sized to receive the exterior profile 84 of the second connector 64 to increase the stability of the connector 28.

The sleeve 88 may have a threaded region 98 provided on all or a portion of the inner profile 96. The threaded region 98 of the sleeve 88 may engage the threaded region of the peripheral region 70 of the first connector body 66 to provide a secure engagement of the first connector 62 to the second connector 64 without the use of tools.

In another embodiment, the sleeve 88 may move transversely over the first connector 62. An aperture 92 may be sized to receive the first connector body 66 to allow movement of the sleeve. The second region 94 having an inner profile 96 may be sized to receive the peripheral region 70 of the first connector 62. The threaded region 98 may engage with a threaded region provided on the peripheral region 70 of the second connector 74.

In at least one embodiment, one or more sleeve portions can be sized receive and engage an end portion of the first and/or second bicycle frame portions 24 and 26 proximate to the engaged portion of sleeve 88. The one or more frame sleeve portions can be utilized to support the bicycle frame end portions, and/or conceal the brazing and/or pinning of the first and second connectors 62 and 64.

Referring now to FIG. 6, a retainer 106 is provided through the body 74 of the second connector 64. The retainer 106 has a leading edge 108 and an abutting edge 10 which abuts the sleeve 88. The retainer 106 helps retain the sleeve 88 so that the sleeve 88 may be in threaded engagement with the first connector 62. The retainer 106 may have a biasing member 112 such as a spring for extending the retainer 106 after it is retracted below the surface of the second connector body 74. The biasing member 112 allows the retainer 106 to retract into the second connector body 74 to allow the sleeve 88 to move transversely over the retainer 106. The abutting edge 110 may have a larger area than the leading surface 108 to facilitate the transverse movement of the sleeve 88 there over.

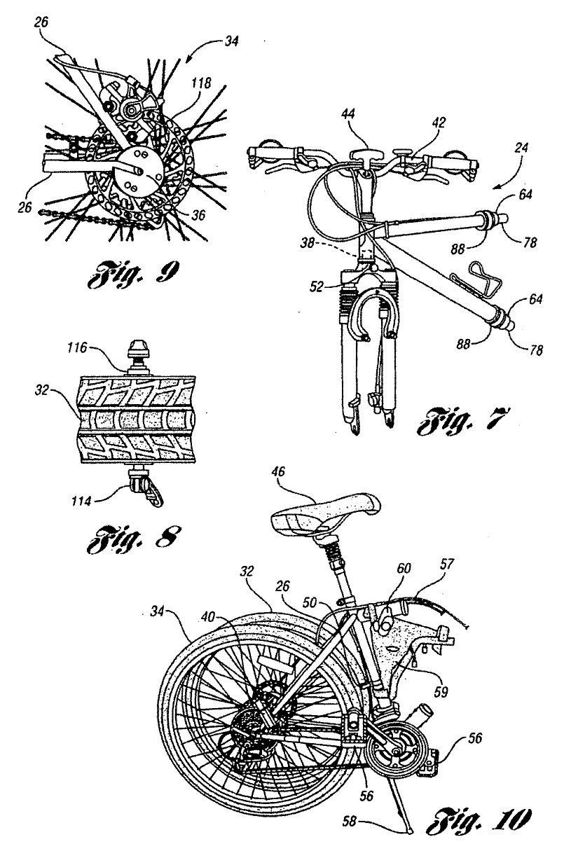

With reference to FIG. 7, a first bicycle frame portion 24 is illustrated. The first bicycle frame portion 24 may be connected to the second connector 64 as illustrated. In another embodiment, the first bicycle frame portion 24 may be connected to the first connector 62. The first bicycle frame portion 24 is provided with a first yoke 38 which may be an aperture formed in the first bicycle frame portion 24. A pair of handle bars 42 may be provided on the first bicycle frame portion 24. The handle bars 42 are moveably connected to the first bicycle frame portion 24 and may have a release mechanism 44 to allow movement relative to the first bicycle frame portion 24. The release mechanism 44 allows for the first bicycle frame portion 24 to be stored or transported in a compact assembly.

Referring now to FIG. 8, the first tire 32 of bicycle 20 is illustrated disassembled from the first bicycle frame portion 24. The first tire 32 may be provided with a quick release 114 as illustrated. On an opposite side from the quick release 114, the tire 32 may be provided with a mechanism 116 to allow the first tire 32 to be supported by the second bicycle frame portion 26 when in a compact transportable assembly as illustrated in FIG. 2.

With reference to FIG. 9, an enlarged partial view of the second tire 34 is depicted. The second tire 34 is operatively connected to the second bicycle frame portion 26. A brake system 118 is illustrated. Any suitable brake system 118 is contemplated within the scope of the present invention. A hub 36 is provided on the second bicycle frame portion 26. The hub 36 is sized to receive the mechanism 116. The support of the hub 36 of the mechanism 116 allows the first tire 32 to be operatively connected to the second bicycle frame portion 26 which is illustrated in FIG. 10.

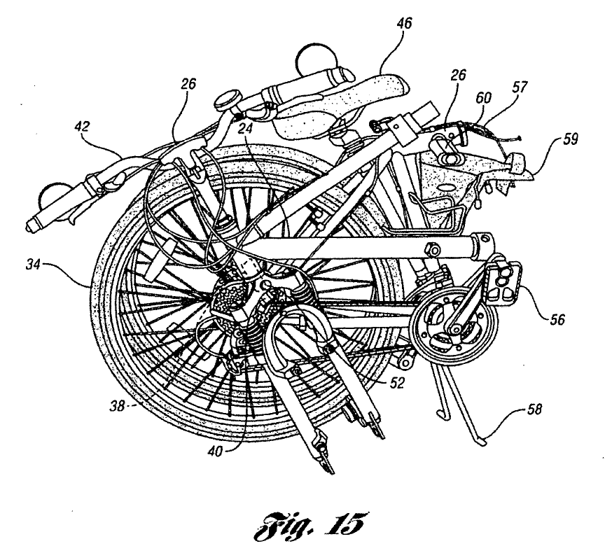

In FIG. 10, the second bicycle frame portion 26 is illustrated disassembled from the first bicycle frame portion 24. The second bicycle frame portion 26 is in operative connection with the first tire 32 and the second tire 34. The brake and gear connectors 57 have been disconnected and the second portion of the brake and gear connectors 57 are illustrated. The detachable seat frame 46 may be removed from the position illustrated and stored within the seat retainer 50 as illustrated in FIG. 13.

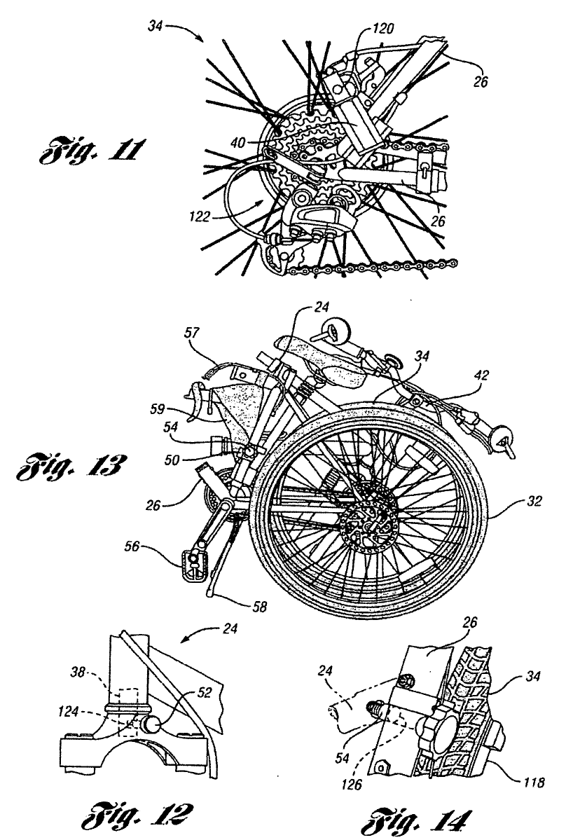

Referring now to FIG. 11, a side perspective of the second tire 34 Is illustrated. The second tire 34 is operatively connected to the second bicycle frame portion 26. A gear system 122 may be provided to operatively connect the second tire 34 to the peddle 56, which is well known in the art. A second yoke 40 may be provided on the second bicycle frame portion 26. The second yoke 40 is sized to receive the first yoke 38 of the first bicycle frame portion 24 which is illustrated in FIG. 12. The second yoke 40 may also have a recess or aperture 120 provided therein.

With reference now to FIG. 12, the first bicycle frame portion 24 of FIG. 7 is illustrated enlarged. A first yoke 38 is provided in the first bicycle frame portion 24. The first yoke 38 is sized to receive the second yoke 40 which allows the first bicycle frame portion 24 to be mounted to the second bicycle frame portion 26 for a compact transportable assembly. The first yoke 38 may have an aperture transversely therein to receive a retainer 52. The retainer 52 may be aligned with the recess or aperture 120 of the second yoke 40 to secure the first bicycle frame portion 24 to the second bicycle frame portion 26 as illustrated in FIG. 15.

Now referring to FIG. 13, the bicycle 20 of FIGS. 1 and 2 is illustrated in a compact transportable assembly. The seat 28 may be removed from the second bicycle frame portion 26 through the use of a quick release 48. The seat 28 may be stored in a seat retainer 50 provided on the second bicycle frame portion 26.

A retainer 54 may be provided through the second bicycle frame portion 26 to secure the first bicycle frame portion 24 thereto. As illustrated in FIG. 14, an aperture 126 is provided through the second bicycle frame portion 26. A second aperture 118 is formed in the first bicycle frame portion 24. The retainer 54 is provided through the first aperture 126 into the second aperture 118 to secure the first bicycle frame portion 24 to the second bicycle frame portion 26 when in a compact transportable assembly.

In FIG. 15, the bicycle 20 of FIGS. 1 and 2 is shown from a side perspective view. The front bicycle frame portion 24 is secured to the second bicycle frame portion 26 by inserting the second yoke 40 into the first yoke 38 and securing a retainer 52 thereto. A handle 60 is provided on the second bicycle frame portion 26 to facilitate movement of the bicycle 20 in the compact assembly. A user may roll bicycle 20 on first tire 32 and second tire 34 which are in operative contact with an underlying support surface.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention

What is claimed is:

1. A connector assembly for assembling at least two portions of a bicycle frame, the connector assembly comprising:
a first connector having a body adapted to be mounted to the bicycle frame the body having an inner aperture, a peripheral region oriented at a distal end of the first connector, the peripheral region having an axial contact surface, and a threaded exterior profile greater than an outer profile of the body;
a second connector having a body adapted to be mounted to the bicycle frame with an exterior profile and a pilot extending there from being sized to be received in the first connector inner aperture, the body having a peripheral region with an exterior profile and an axial contact surface for abutting the first connector axial contact surface; and
a sleeve having a first region with an aperture formed there through sized to receive the second connector body exterior profile for axial translation relative thereto, the sleeve having a second region with an inner profile sized to receive the second connector peripheral region exterior profile, the sleeve having a threaded region for threaded engagement with the first connector threaded exterior profile for fastening the first connector to the second connector, maintaining engagement of the pilot in the first connector inner aperture and maintaining engagement of the first and second connector axial contact surfaces.

2. The connector assembly of claim 1 further comprising a retainer provided on the body of the second connector, the retainer abutting sleeve the when the sleeve is engaged with the exterior profile of the first connector.

3. The connector assembly of claim 2 wherein the retainer has a leading surface provided opposite of an abutting surface such that the abutting surface abuts the sleeve when the sleeve is engaged with the exterior profile of the first connector. the leading surface having an area less than an area of the abutting surface allowing for translation of the sleeve in one direction across the retainer when not engaged with the threaded exterior profile of the first connector.

4. The connector assembly of claim 4 further comprising a biasing member for urging the retainer to an extended position abutting the sleeve.

5. The connector assembly of claim 1 further comprising: a second aperture formed transversely in the first connector body intersecting the inner aperture;
a recess formed transversely in the pilot aligned with the first connector second aperture; and
a retainer sized to be received through the first connector second aperture and into the recess for aligning the first and second connectors while assembling the connector assembly.

6. The connector assembly of claim 5 further comprising a biasing member for urging the retainer to an extended position into the recess of the pilot.

7. The connector assembly of claim 1 wherein the first connector body has a diameter and the second connector body has a diameter.

8. The connector assembly of claim 7 wherein the sleeve first region aperture has a diameter and the sleeve second region inner profile has a diameter.

9. The connector assembly of claim 8 wherein the first connector inner aperture has a diameter, the first connector threaded exterior profile has a diameter, the first connector body outer profile has a diameter, the second connector body outer profile has a diameter, and the second connector exterior profile has a diameter.

10. A bicycle comprising: a first bicycle frame portion;
a first tire mounted for rotation to the first bicycle frame portion; a first connector mounted on the first bicycle frame portion, the first connector having a body with an inner aperture, a peripheral region oriented at a distal end of the first connector, the peripheral region having an axial contact surface, and a threaded exterior profile greater than an outer profile of the body;
a second bicycle frame portion;
a second tire mounted for rotation to the second bicycle frame portion;
a second connector mounted on the second bicycle flame portion, the second connector having a body with an exterior profile and a pilot extending there from being sized to be received in the first connector inner aperture, the body having a peripheral region with an exterior profile and an axial contact surface for abutting the first connector axial contact surface; and
a sleeve having a first region with an aperture formed there through sized to receive the second connector body exterior profile for axial translation relative thereto, the sleeve having a second region with an inner profile sized to receive the second connector peripheral region exterior profile, the sleeve having a threaded region for threaded engagement with the first connector threaded exterior profile for fastening the first connector to the second connector, maintaining engagement of the pilot in the first connector inner aperture and maintaining engagement of the first and second connector axial contact surfaces.

11. The bicycle of claim 10 further comprising: a third connector mounted on the first bicycle frame portion, the third having a body with an inner aperture, a peripheral region oriented at a distal end of the first connector, the peripheral region having an axial contact surface and a threaded exterior profile greater than an outer profile of the body;
a fourth connector mounted on the second bicycle frame portion, the fourth connector having a body with an exterior profile and a pilot extending there from being sized to be received in the third connector inner aperture, the body having a peripheral region with an exterior profile and an axial contact surface for abutting the third connector axial contact surface; and
a second sleeve having a first region with an aperture formed there through sized to receive the fourth connector body exterior profile for axial translation relative thereto, the second sleeve having a second region with an inner profile sized to receive the fourth connector peripheral region exterior profile, the second sleeve having a threaded region for threaded engagement with the third connector threaded exterior profile for fastening the third connector to the fourth connector, maintaining engagement of the pilot in the third connector inner aperture and maintaining engagement of the third and fourth connector axial contact surfaces.

12. The bicycle of claim 10 wherein the first tire is detachable from with the first bicycle frame portion;
wherein the second frame portion further comprises a hub for selective attachment of the first tire for assembling the bicycle in a compact transportable assembly.

13. The bicycle of claim 12 further comprising:
a first yoke provided on the first bicycle frame portion; and
a second yoke provided on the second bicycle frame portion, the second yoke sized to receive the first yoke such that the first bicycle frame portion remove ably connects to the second bicycle frame portion for assembling the bicycle in the compact transportable assembly.

14. The bicycle of claim 13 further comprising:
a transverse aperture formed transversely in the first bicycle frame portion through the first yoke;
a recess formed in the second yoke aligned with the first bicycle frame portion aperture; and
a pin sized to be received through the aperture and into the recess to the secure first bicycle frame portion and the second bicycle frame portion together.

15. The bicycle of claim 13 farther comprising: a first transverse aperture formed transversely in the first bicycle portion;
a second transverse aperture formed transversely in the second bicycle frame portion aligned with the first aperture; and
a pin sized to be received in the first and second apertures to secure the first bicycle frame portion and the second bicycle frame portion together.

16. The bicycle of claim 13 further comprising a detachable handle provided on second bicycle frame portion.

17. The bicycle of claim 10 further comprising a pair of handle bars adapted to moveably connect to the first bicycle frame portion, the handle bars provide with a release mechanism.

18. The bicycle of claim 10 further comprising a bicycle seat operatively connected to the second bicycle frame portion for a user to sit there upon, the seat provided with a release mechanism for disassembling the seat from the second bicycle frame portion.

19. The bicycle of claim 18 further comprising a seat retainer provided on the second bicycle frame portion such that the seat is retained by the seat retainer when disassembled from the second bicycle frame portion for assembling the bicycle in a compact transportable assembly.

20. A method of disassembling a bicycle comprising: disassembling a first bicycle frame portion from a second bicycle frame portion; and
assembling the first bicycle frame portion to the second bicycle frame portion for assembling the bicycle in a compact assembly.
